(19) United States
(12) Patent Application Publication
(10) Pub. No.: US 2002/0144136 A1
(43) Pub. Date: Oct. 3, 2002

(54) Device and method of mediating access

(76) Inventors: Wakefield Scott Stornetta JR., Morristown, NJ (US); James D. Hollan, La Jolla, CA (US)

Correspondence Address: Frank Chau, F. CHAU & ASSOCIATES, LLP, Suite 501, 1900 Hempstead Turnpike, East Meadow, NY, 11554, US

(21) Appl. No.: 09/778,301

(22) Filed: Feb. 7, 2001

(51) Int. Cl. H04L 9/00; H04L 9/32

(52) U.S. Cl. 713/200

(57) ABSTRACT

A method of mediating access to a person via a communication medium, comprising the steps of: creating one or more filters, each filter including information defining an individual's ability to arrange access to the person, and at least one parameter used to identify the individual to whom the access is to be granted; identifying the individual when the individual attempts to arrange access to the person; determining an appropriate filter based on identification of the individual; and arranging for access to the person by the individual within the constraints established by the appropriate filter.

### BACKGROUND OF THE INVENTION

1. Technical Field

The present invention relates to a device and method for mediating access to a person or person's availability information; more particularly, a device and method for establishing access to a person or person's availability information over an electronic network.

2. Description of Related Art

Consider the everyday task of scheduling a meeting. If those involved are in close proximity, the most common approach is for the person initiating the meeting to speak directly with the other people they want to meet with to compare calendars, share the state of relevant activities and commitments, discuss options, and ultimately decide on a mutually agreeable meeting time.

When the parties are not in close proximity, a similar process of mediation or negotiation often takes place over the phone. In both cases, the parties participate in real time. Scheduling by phone is complicated because it is often difficult for parties to reach one another. What frequently results is a game of phone tag. One party tries to reach another, is unable to, and leaves voice-mail indicating an interest in finding a time to meet. The other party returns the call, more often than not fails to reach the original caller, and leaves voice-mail in response. The process routinely entails multiple iterations, with the participants leaving suggested times to meet, confirming previously mentioned times, or proposing new times. The negotiation is inefficient and frequently tedious. The process is further complicated as the number of meeting participants increases.

People commonly remove themselves from mediating schedules by having a secretary participate on their behalf. A principal virtue of this is the secretary is available by telephone throughout the day, so the back and forth problem of phone tag ends as soon as people initially contacted call back. The secretary has access to their employer's calendar as well as knowledge of other constraints and is able to negotiate a time for the appointment.

A process similar to this phone-tag mediation is now often carried out via electronic mail. A person proposes a meeting in email, perhaps suggesting potential times for the to-be-scheduled meeting, and the process proceeds through email acceptance or counterproposal until a time acceptable to all involved is negotiated. Though this process may be less frustrating than phone tag, it can still stretch out over an extended period before agreement is reached. It is also possible that by the time one of the participants responds another participant's schedule may have changed due to the lack of timely response to a suggested potential time or to a conflicting obligation arising. It is the nature of asynchronous interactions that a proposed time may no longer be valid by the time all parties respond and commit to it.

Calendar sharing software has been proposed as a solution to some of these problems. For example, in a typical calendar-sharing approach, all parties keep appointment calendars in electronic form using compatible software. Someone wanting to schedule a meeting can view other people's calendars, see the times they are available, choose an appropriate time, and notify everyone involved of the meeting time, without the other parties ever needing to be involved in the negotiation. Microsoft's Outlook can be used to effect this scheduling process.

A problem with calendar-sharing systems is the requirement that all parties must maintain and continuously update their calendars in electronic form. The payoffs for these added burdens are often not equitably distributed. There are large costs associated with keeping schedules updated, and payoffs frequently may not be worth the effort for many of those involved. Grudin discusses this in terms of who does the work and who gets the benefit. He notes that such systems often fail because while requiring everyone involved to keep their calendar online and current, often only managers derive benefit. Second, because such schemes allow people to view and modify the calendars of others, calendar sharing is limited to close associates who feel comfortable allowing such access. While it is not an uncommon practice for people working within the same organization to use calendar-sharing systems, they fail to meet the needs of those who: (1) do not use the same software, (2) are in separate organizations without needed connections, (3) do not find the reward-to-effort tradeoff suitably beneficial, or (4) do not feel comfortable sharing their calendars.

Knowing a person's schedule provides valuable information about their activities and raises complex confidentiality and security issues. In some calendar-sharing software, this is addressed in part by masking out the details of appointments. When someone else is viewing the calendar, only times available are presented but this is still information not everyone wants to share. If there is even one person an individual does not feel comfortable sharing his or her schedule with, then there is incentive not to participate in calendar sharing. Without universal acceptance of the sharing scheme, the whole process can become fragile and break down. In a significant number of situations, for the reasons listed above, it is simply not practical to use calendar-sharing software to schedule a meeting.

The same fundamental problems exemplified above in arranging meetings are also confronted in a variety of other situations. Consider instant messaging for example. The recent growth in instant messaging (IM) systems, as well as wireless access, presages a world where one is continuously available for interaction. In such a setting, there will be a growing need to restrict and negotiate access.

Instant messaging and similar chat facilities evolved from the talk command on early Unix systems. Talk was used for synchronous short text-based interactions, while email was used for longer messages sent asynchronously. This mechanism was adequate so long as (1) the number of users on the system remained small, (2) users were likely to be acquainted with each other (which was typically the case, by virtue of working in the same small group), and (3) they were only logged on the system a relatively small fraction of their day.

Over time, this basic mechanism was expanded to handle collections of computers connected via multiple networks and resulted in a very large number of aggregate users. As a consequence, condition (1) no longer held. If all current users were notified each time a new user logged on, this would create almost constant interruptions. In addition, as networks grew larger, most users were no longer associates, in either a social or work-related sense. Thus, condition (2) no longer held. Users don't want information about their presence or absence on the system to be broadcast to other users they don't even know. These circumstances led to the creation of “buddy lists”, collections of people with whom one wishes to have instant messaging communication. Thus, today when a user logs onto a typical system, only those people who have the user on their buddy list are notified.

Instant messaging has now expanded beyond text to include voice. A real-time audio channel can be opened and remains continuously on, analogous to a text-based IM window remaining on the screen. While this is advantageous when both parties desire increased access to each other, the audio version of IM can be even more invasive than a text version, and leads to the need to further regulate access in situations where parties want to insulate themselves, at least temporarily, from access. In addition, the growth of wireless connectivity and other “always-on” systems creates a situation in which users can be logged on nearly continuously. In such circumstances, condition (3) no longer holds. As a result, additional means will increasingly be needed to regulate one's availability for instant messaging and similar forms of access.

Accordingly, there exists a need for an access mediating apparatus and method for alleviating the problems of the prior art, such as: proposed times being out-of-date; restricted access to calendars and other state information; requiring scheduling parties to share identical software; and burdensome overhead on others involved in the access scheduling process. It is desirable that the apparatus and method mediate access including (1) allowing the process to evolve without the need for participants to devote time unnecessarily to the scheduling process (or more broadly, the access mediation process) itself, such as the multiple iterations typical of phone tag or email exchanges to arrange meetings, and (2) creating a common integrated process to support not only effective scheduling of meetings but also mediating access to peoples' attention and work products.

### SUMMARY OF THE INVENTION

A method is provided for mediating access to a person's availability information via a communication medium, comprising the steps of: creating one or more filters, each filter including information defining how the availability information is to be presented, a parameter used to identify an individual to whom the access is to be granted, and associating a filter with the individual; identifying the individual when the individual attempts to access the filtered information; retrieving the filter associated with the individual; and presenting to the individual up-to-date availability information processed by the associated filter.

According to still another aspect of the invention, a method is provided for mediating access to a person via a communication medium, comprising the steps of: creating one or more filters, each filter including information defining an individual's ability to arrange access to the person, and at least one parameter used to identify the individual to whom the access is to be granted; the individual attempting to arrange access to the person; identification of the individual and determination of the appropriate filter; and arranging for access to the person by the individual within the constraints established by the appropriate filter.

The method preferably includes the step of deactivating said one or more filters upon satisfaction of a preset condition relating to said filter, such condition being established as part of the creation of the filter.

According to a further aspect of the invention, the method includes the step of associating a token with each filter, giving notice of the token to the individual, and use of the token for the purpose of identification of the individual and determination of the appropriate filter.

A program storage device is also provided. The device having stored programs executable by a computer for performing method steps for mediating access to a person, the method comprising the steps of: creating one or more filters, each filter for processing the availability information and to produce filtered information, each filtered information presenting a different version of the availability information; setting parameters from identifying individuals intended to receive filtered information; identifying individuals attempting to access filtered information, and selecting a filter based on the identified individual; and presenting to the identified individual filtered information corresponding to the selected filter.

### BRIEF DESCRIPTION OF THE DRAWINGS

FIG. 1 is a view of a calendar and filter of a person to be accessed according to an embodiment of the present invention;

FIG. 2 is a view of the calendar presented to an identified recipient;

FIG. 3 is another view of the calendar of the person;

FIG. 4 is another filtered view of the calendar for the recipient;

FIG. 5 is a telephonic implementation of an embodiment of the present invention;

FIG. 6 is an exemplary flow diagram of a method according to the present invention;

FIG. 7 is another exemplary flow diagram of another embodiment of the method according to the present invention; and

FIG. 8 is still another embodiment of the method according to the present invention.

### DETAILED DESCRIPTION OF PREFERRED EMBODIMENTS

A process according to the present invention mediates access to a person or a person's availability information and selectively shares the state of the person's activities in collaborating with others, arranging meetings, and coordinating access to shared information. Embodiments of the invention mediate access and include functions of scheduling meetings, contacting others in real time (by phone or instant messaging), or by email.

A method according to the present invention can best be illustrated by an example of two persons attempting to schedule a simple meeting via email. Imagine Irving wants to schedule a meeting with a business associate Roberta. He begins by composing an email message to her. It might be something like:

Roberta,

I've been thinking more about your proposal and would like to discuss it. I'm in and out of the office a lot this week, so the best thing to try is probably scheduling a time that both of us are available. You can choose a time for us to talk simply by clicking on the link at the bottom of the page. That link gives you a one-time access to my calendar, and will allow you to pick a time for us to talk.

Regards—Irving

After completing the body of his email message, Irving invokes an application which brings up a view of his calendar. He then makes some specific selections relating to the meeting he wishes to schedule with Roberta. For example, he may bound the time he wishes to talk with Roberta to be within a three-day period. Additionally, because this is a business meeting, he may specify that it take place only between the hours of 9 a.m. to 5 p.m. on any given day. He may also identify particular meetings, already scheduled, which he is willing to override if Roberta wishes to meet at that time. When he is finished making his selections, a token is created which will be associated with these choices and appended to a URL which is inserted at the bottom of the email message.

The completed email message might look like:

From: Irving@equi-poise.com

To: Roberta@hci.ucsd.edu

Roberta,

I've been thinking more about your proposal and would like to discuss it. I'm in and out of the office a lot this week, so the best thing to try is probably scheduling a time that both of us are available. You can choose a time for us to talk simply by clicking on the link at the bottom of the page. That link gives you a one-time access to my calendar, and will allow you to pick a time for us to talk.

Regards, Irving

www.irving.com/schedule.cgi?1076

After Roberta receives the email and decides she wants to schedule the meeting, she simply clicks on the URL. There are two parts to the URL: a path to a cgi-bin program for accessing Irving's calendar and a parameter that is a token used to generate a filtered view of Irving's calendar. Roberta will then see a web page displaying Irving's calendar; particularly, a specific filtered view of Irving's calendar. Consistent with Irving's choices, only a 3 day period of the calendar is shown, and only times from 9-5 are shown. Times where existing meetings are scheduled are also blacked out, with the exception of any meetings that Irving designated as ones Roberta could override. A program that is run in response to Roberta's click generates this web page. It checks the token to ensure it is the unique token that was used to specify the meeting Irving requested and if verified allows Roberta a one-time access to the calendar to choose an appointment time within the constraints Irving imposed.

Once Roberta selects a time, the calendar is updated, and the token “1076”is deactivated. In other words, if Roberta or anyone else attempts to use the URL at a later time, they will not be allowed access to Irving's calendar, or even a filtered view of the calendar. (If desired, cryptographic processes can be used to make the process more secure including making the token infeasible to guess.) Finally, Irving is automatically notified, by email or other means, that Roberta has confirmed their meeting.

It can be seen that this process removes problems associated with approaches mentioned above. Irving did not send a proposed set of meeting times explicitly in his email. Instead he sent a token that provides a mechanism to access a filtered view of his calendar. If, in the interim between when he sent the message and Roberta responded, his calendar changes, the filtered view Roberta will see can still be current. Irving and the automated negotiation process retain control over possible times until the other party responds. However, also notice that Roberta benefits from this process by being presented choices that are current at the time of access and the effort required of her is minimal. The effort to specify the filter, generate the associated token and keep his online calendar current is done by Irving, the person wanting to schedule the meeting. Note that Roberta is given the ability to modify Irving's calendar. Thus, the person desiring the benefit is the person required to do most of the work, while the other party simply schedules the meeting at their convenience.

Advantages of the illustrative process are further illustrated in the following application. Suppose an employer needs to meet with eight job candidates applying for a position opening. He has a block of four hours during which he can conduct interviews, and he would like to meet for 30 minutes with each candidate. In a conventional system the employer might propose specific times in email or voicemail messages to the candidates. However, the times proposed to a given candidate may not work for that person, whereas he or she could be available at a time proposed for a different candidate. If one candidate could swap times with another, then potentially everyone's scheduling needs could be satisfied. Unfortunately, working through this might take several rounds of email or voicemail.

Advantageously, a process according to the present invention offers significant improvements for mediating access. For example, the employer could send out eight emails, each with a separate token, but with each token giving access to the same four hour block. After the first candidate who accesses the calendar chooses a time, that time slot is marked as used. The next candidate to access the calendar sees only the seven remaining choices, and so on for the other candidates. In a further embodiment, the candidates can indicate subsets of the possible times that fit their schedules, or even indicate priorities for those times. Then as each person accesses the schedule via their token the schedule is in an updated state based on all previous interactions.

It is readily apparent to one skilled in the art that the illustrative method according to the present invention affords the unique flexibility provided by asynchronous mediated access to a filtered and dynamically updated database of state information. Arranging any multi-person meeting may benefit from application of the process disclosed herein. At a minimum, if Irving is asked to participate in a multi-person meeting, he can simply send a token-embedded email message to the person responsible for coordinating the meeting. His involvement is limited to the one action at the time he gets the request, rather than being interrupted with phone calls or further emails trying to juggle times.

Although the calendar-scheduling embodiment disclosed above is applicable to the Internet, the embodiment need not occur over the Internet using a browser to view the calendar and a token embedded in an email message for accessing the filtered view. The token can be given over a different medium. For example, one could also leave a token in a voicemail message (asynchronously), or simply tell the person in a face-to-face meeting or phone conversation what the token is (synchronously). In addition, the calendar view and scheduling could be handled by a personal virtual assistant (PVA) such as those available from Wildfire Corporation or Call Sciences Corporation. In this case, it could use a text to speech system that also responds to voice or DTMF queries over the conventional phone network or cell phones. As illustrated, the tokens are communicated either synchronously (live) or asynchronously to achieve a live session of meeting or access to a person's availability information. Once armed with the token, access to a filter is instantaneous.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

Communications of information pertinent to the present invention, such as tokens, or continually updated location data are preferably implemented via a global electronics network including the Internet, or wired or wireless telephone networks.

Components for implementing the above scheduling process preferably include a calendar program which operate with software modules for implementing functions pertinent to the invention such as creating filters with user select and mask functions. The calendar program can be one known to one skilled in the art such as Microsoft Outlook or equivalent calendar. The software modules further include email delivery program for collection and/or generation of a person's calendar and entry of scheduling information. The person's personal computer executes a stored program embodying modules for creating and selecting filters and filtered views. Microsoft's Explorer or Netscape's browser can be used to present the filtered views to an intended recipient.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

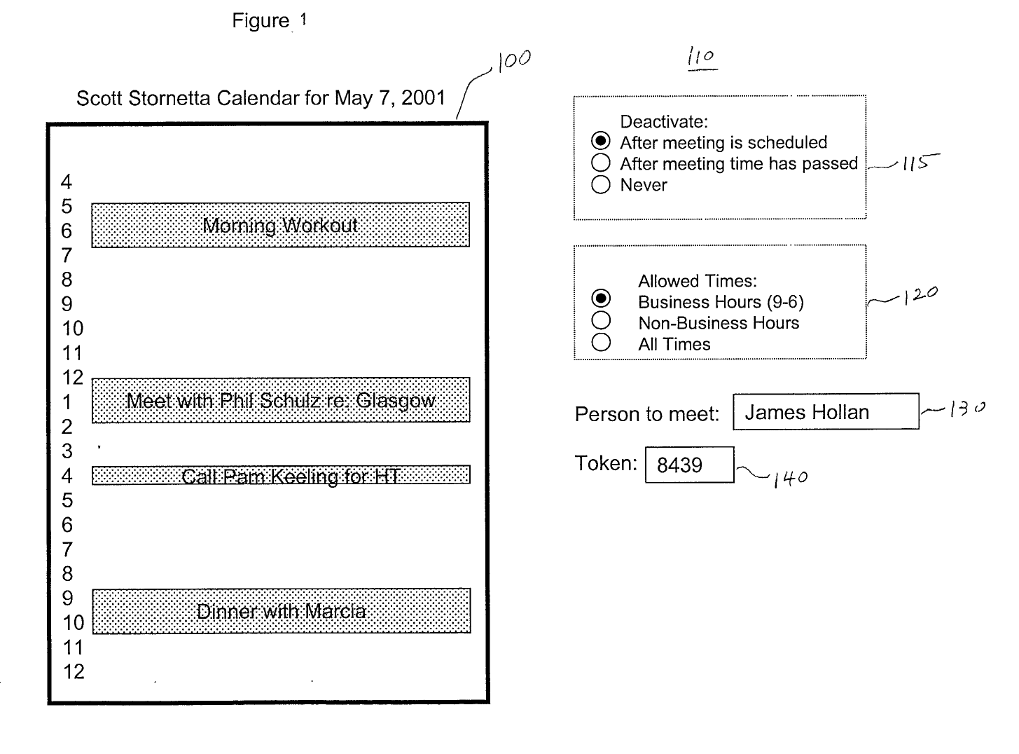

The invention will now be described with references to FIGS. 1 to 4.

FIG. 1 is a view of a calendar of the person who is offering access to his calendar, and is setting the parameters of a filter. FIG. 1 shows the calendar 100 for the person, in this case, one of the inventors, Scott Stometta. For simplicity's sake, only one day of the calendar is shown. Notice that there are existing commitments already scheduled. The blocks indicate the time and duration of the meetings and the text gives additional information about the meeting topic, and where applicable, with whom the meeting is taking place. Filter area 110 allows the person to set the parameters of the filter.

The condition under which access to the calendar will be terminated is shown in filter element 115. The user has chosen “After meeting is scheduled”. With this condition, once the person has chosen a time for the meeting, the filter will be deactivated, and thus the person will have no access to the calendar after that point. Had the user chosen “After meeting time has passed” then Mr. Hollan would continue to be granted access to the calendar even after he had made his initial selection of meeting time. This would permit him, for example, to reschedule the meeting. The filter would only be deactivated at the point when the scheduled time of the meeting had passed. Had the user chosen “Never” then the filter would remain active indefinitely, and Mr. Hollan would continue to have access to the calendar.

Filter element 120 allows the user to select different times of the day and week available for appointments. While the individual (in this case Mr. Hollan) scheduling the appointment will not be permitted to schedule during the times which meetings are already scheduled, they are also optionally restricted from scheduling during times in which no meeting is scheduled. Specifically, in this example, the user has chosen the option “During business hours (9-6)”. By selecting this, only times from 9 to 6, Monday through Friday, during which no other meeting is planned, will be presented to the individual requesting access. Selecting “During non business hours” would have had the same effect, but this time making morning, evenings and weekends available for scheduling, but not hours during the business day. Selecting “All times” makes the entire calendar available, again with the exception of those times during which meetings are already scheduled.

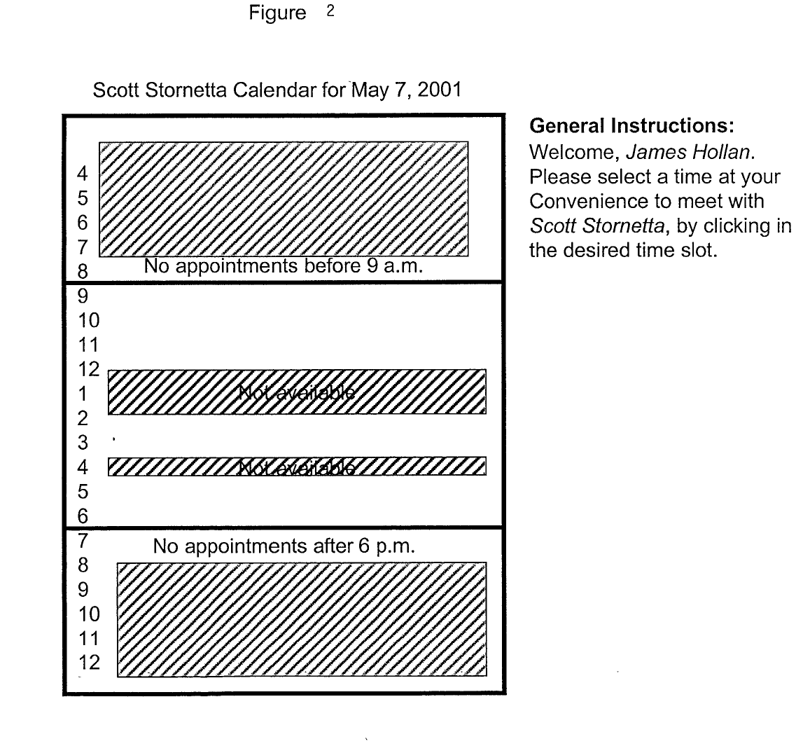

Filter element 130 is part of the filter used to identify the caller and in this case is the name of the person who will be scheduling the meeting. The user enters this information, and it is used later to customize the greeting (see FIG. 2), and in the absence of a token, is used to identify the individual.

Filter element 140, “Token,” displays the number (in this case 8439) chosen by the program to be associated with this filter. This is for display purposes only and is preferably not subject to user control. If token is not used, the name of the person to meet can be used to identify that person.

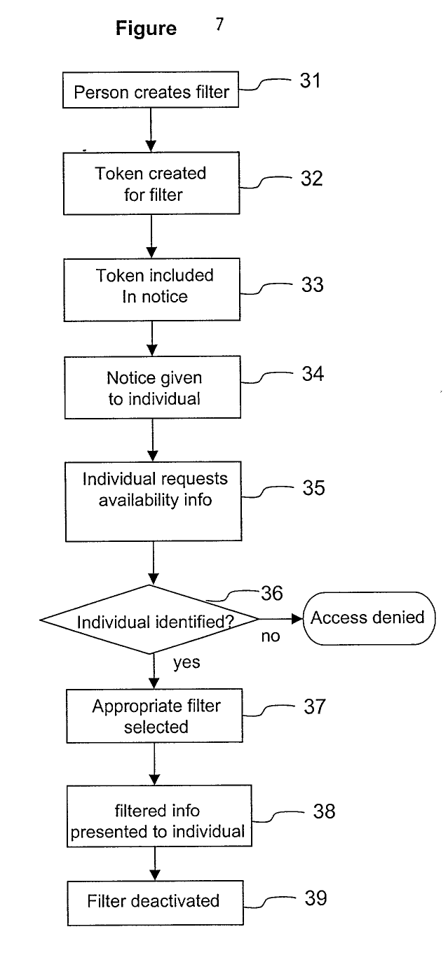

FIG. 2 illustrates the view presented to Mr. Hollan. This is a presentation of the calendar filtered according to the parameters that were set in the filter area 110 of the computer window illustrated in FIG. 7a. Note that not only are the names blocked out, but also times before 9 a.m. and after 6 p.m. are not available—only business hours are available. Mr. Hollan's name is used to greet the person scheduling the meeting.

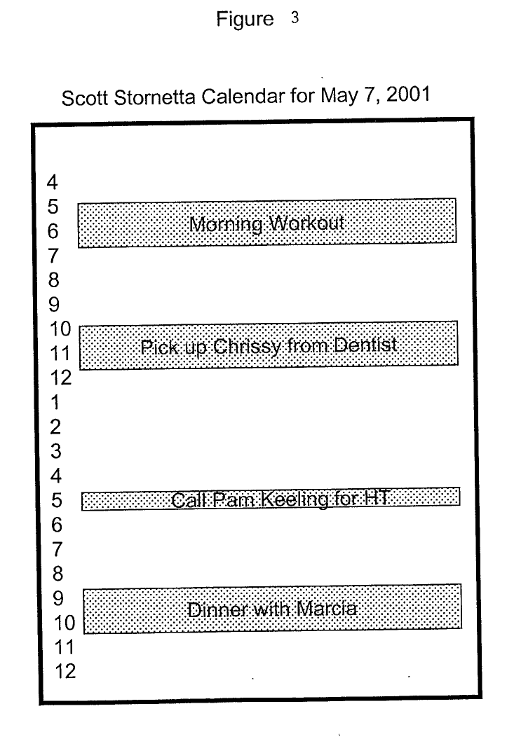

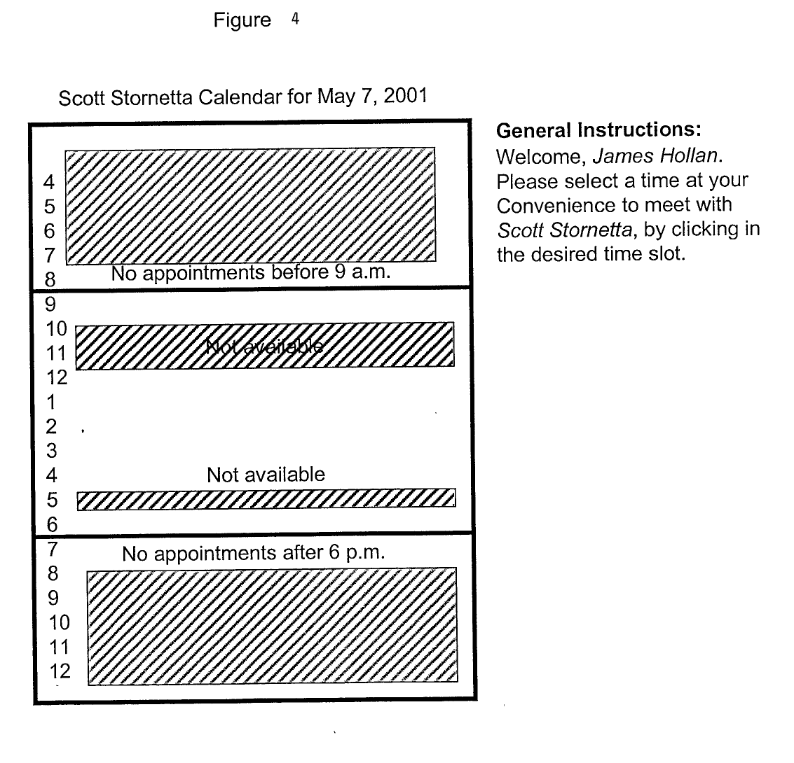

FIG. 3 shows the actual calendar at a later date and time—note that the appointments have changed slightly—one canceled, another moved to a different time, and an additional event added. FIG. 4 shows the same filtered presentation as FIG. 2, but accessed at a different time. Note that though the same filter is used, the information presented is different. Depending on when the associate tries to access the calendar, the filter is always applied to up-to-date information.

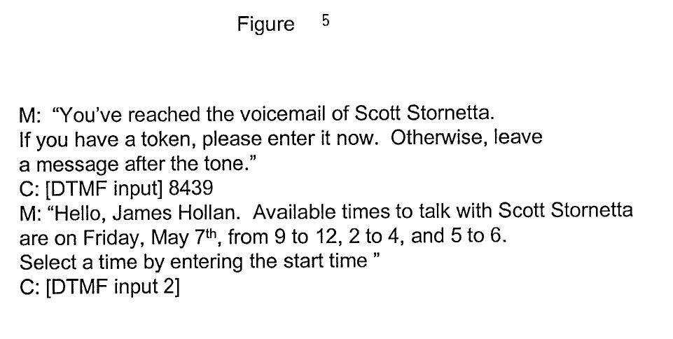

FIG. 5 illustrates a verbal presentation of the same information and filter combination seen in FIG. 4. Rather than accessing the calendar over the Internet, the associate has accessed the calendar over the phone. This illustrates that the presentation of filtered information need not be visual. Further, Scott can employ his computer and a telephone caller ID system to prepare different filters or filtered information for different callers. In such embodiment, Scott first associates filters with callers in his computer database, his caller ID identifies the callers as the calls come in and filters corresponding to the identified caller are presented to the caller. Note that a token is not required, because caller ID can identify the individual.

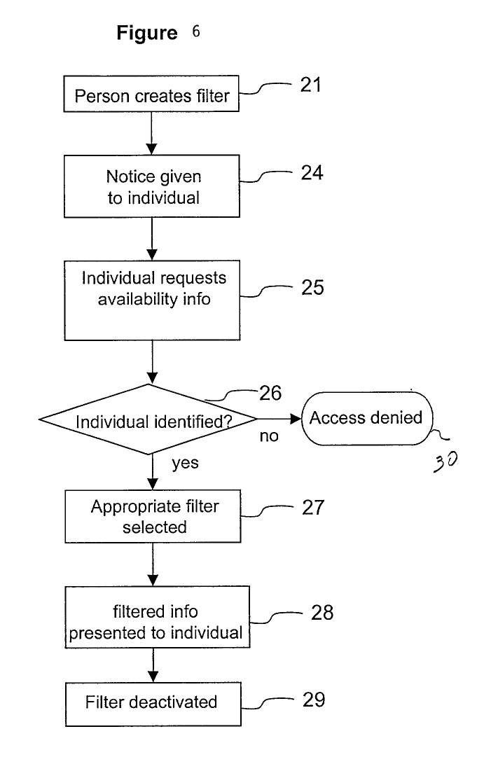

The invention is further explained in reference to the flow diagrams of FIGS. 6 to 10. FIG. 6 shows the illustrative embodiment according to the present invention of mediating access by a person creating a filter 21. Filters according to the present invention select, at the time of presentation, collections of information from the person's database of availability and access information. Each filter specifies the information selected for the caller to the person. Thus, each filter is associated with information to be shown to targeted individuals. For example, filter area 110 of FIG. 1 is used with calendar 100 for selection of use to the targeted recipient. The token is then given to the intended recipient (step 24) in the form of e-mail, telephone call, or other known notification means. In the Irving/Roberta example above, Roberta was notified by e-mail. Upon the intended recipient requesting the person's availability information (step 25) such as by inputting or clicking the token included in the message (steps 32 and 33 of FIG. 7 and element 140 of FIG. 1) the individual is identified (step 26). Upon receiving the token input by the recipient or by identification through known means such as caller ID, digital signatures, an Internet browser “cookie,” the person's computer presents the filter created specifically for that recipient or the filter identified by the token (step 27). The filtered information is then presented to the individual (step 28), as can be seen in FIG. 2. Note that, for added security, the person could require both the token and a caller identification such as by caller ID or digital signature or Internet browser cookie before allowing the caller to gain access to the filter or filtered view. Further, if security is a concern, the token can be made infeasible to guess, e.g., by using a pseudo random number generator to select a number from a sufficiently large space of numbers.

Alternatively, if the recipient can be identified by the person when the recipient seeks access to a filter, such as by caller ID or digital signature or Internet browser cookie described above, the person may choose to dispense with the token approach completely, and generate the corresponding filtered presentations and allow the identified recipient to gain access.

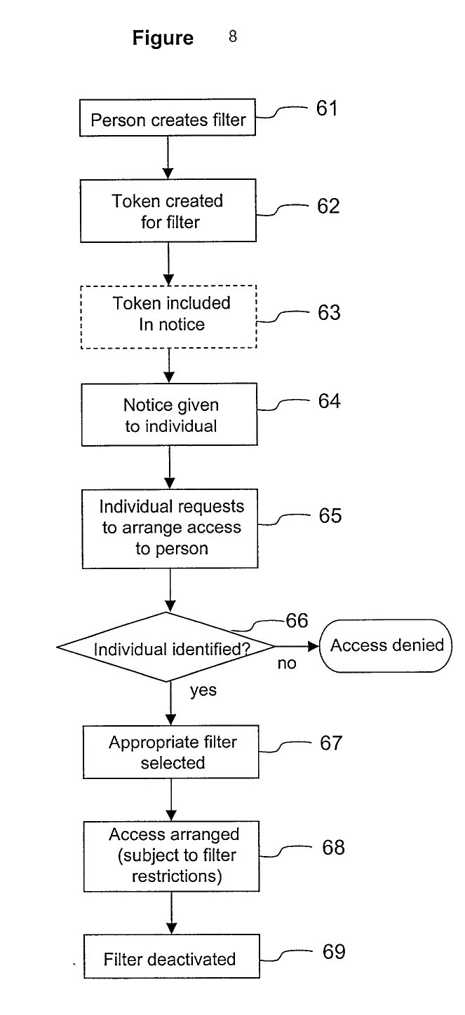

Referring again to FIG. 6, if the activation condition was set by the person and the recipient satisfied that condition, for example, James Hollan having entered a time for meeting (see FIG. 1), the information selected by the recipient is received by the person and the filter is deactivated (step 29), after which the recipient can no longer access the calendar. If the recipient did not properly reply or did not enter a proper token, the access to the calendar would be denied (step 30). Referring to FIG. 8, the steps of FIGS. 6 and 7 are shown, except according to this embodiment of the invention, the calendar is rearranged when the person's schedule has changed and the person knows that the recipient has not made a selection in the calendar. Thus, the access was arranged subject to filter restrictions (step 68) and an updated review is presented to the recipient when the recipient accesses the filter (FIGS. 2 and 4).

The illustrative access mediating method according to the present invention is applicable to instant messaging. According to this embodiment of the invention, each individual or group can be provided with a token similar to the one used in the scheduling example. A web-based server can be employed to act as a mediating intermediary. The mediation could result, for example, in selectively and temporarily altering buddy-list members described earlier. Just as in the case of meeting scheduling, the identity of the token is checked and the associated filter determines whether access to the person they seek is made available. Since access can be tailored to the token, at the same instant people could be available for IM to one set of individuals (perhaps those with whom they are working to meet an approaching project deadline) and not to others. Another example from the academic world would be a professor making himself available for virtual office hours via instant messaging. Students could be given tokens that obtain IM access only during the weekly office hours, and which expire at the end of the term. Notice that mediation can take into account any of the person's availability information at the time of attempted access. This is particularly advantageous because it gives all parties fine-grained control over access. So for example, whether a particular filter shows someone available for IM could be made, via the instructions in the filter, to show availability only when there is not a meeting scheduled in the personal calendar.

In addition to instant messaging, pagers and cell phones further increase accessibility and the need to regulate access. In fact, some people use access to their pager and cell phone numbers to distinguish between an outer circle of acquaintances and a more intimate inner circle of friends. They do this by simply giving the outer circle only their office phone number, and giving the inner circle their pager or cell phone number. A difficulty arises when there is a need, perhaps involving an urgent matter, for someone from the outer group to reach them via their pager or cell phone. To facilitate this, one is motivated to reveal one's cell phone or pager number. The side effect of this is that the inner circle expands, as it's not possible to ask the person to forget the number. It's also socially awkward to say: now that we've taken care of this issue, please don't ever call me on my cell phone again. Again, people can make use of secretaries to negotiate this form of access. The secretary determines which calls merit urgent contact, or at least provide a screen by querying the person whether they want to take the call or not, and can connect a call without disclosing the cell phone number. Personal Virtual Assistants attempt to simulate this same process. Nevertheless, it still leads to the need to query the person to see if they desire to take the call, which can be disruptive and time-consuming.

Allowing one more person access to the inner circle is at least a nuisance. As this process is repeated for multiple exceptional circumstances, the advantages of having the inner circle can seriously degrade. These outer/inner distinctions are present in a number of examples, including ones we've already noted, namely:

| Access Medium | Outer Circle | Inner Circle |
|---|---|---|
| Calendar | No Access | Access via secretary |
| Calendar | Access via secretary | Direct Access |
| Instant messaging | Standard directory | Buddy lists |
| Telephony | Work number | Home number |
| Telephone | Secretary number | Cell phone/pager |
| | | number |
| Email | Standard email address | Wireless/personal |
| | | email address |
| Email with conventional | Email filtered out | Email passed thru |
| filters | | |
| Email with conventional | Normal priority | Forward to cell |
| filter | | phone/pager |

With these concepts of inner and outer circle in place, we now offer some additional examples of the methods originally applied to the calendar scheduling problem.

Returning to the example of calling the PVA number, and then having the PVA try to reach the cell phone, let us assume that a user wants someone to have one-time access to their cell phone, because of an urgent issue they are working on that needs resolving. Rather than try to schedule a call, the user wants this person to reach them as soon as possible. The user provides the other person (in a conversation or in a voicemail or email message) a token that provides one-time access to his cell phone. He sets up a related filter, with the token and filter to be deactivated after a call is completed. Now when this person calls the PVA number, it allows him to speak or use DTMF to enter his token, at which point the call is put through. Once the call is completed, the filter is deactivated. The person has allowed the recipient an automated way of reaching him without disclosing his cellular phone number.

According to a further aspect of the embodiment of the invention, additional database information is integrated from one's calendar to mediate the interaction. The filter could be specified to let the call through only at times when the person is not in the middle of a scheduled meeting. In instances such as this, the PVA could inform the caller that the person is presently in a meeting. In addition, the filter could use the information in the calendar to suggest the earliest point in time when the recipient should be free to take the call. An even more elaborate embodiment of the invention includes GPS information. In this GPS based embodiment, filters are selected to allow or not allow contact depending on the location detected by the GPS receiver at the time of the call. Thus, if a person wears a GPS device, information about his location could be used to determine whether or not to put through a call. For example, when a caller calls when the person is in the office, the call is put through, but when the caller calls when the person is at home, the call is not put through.

A process according to another embodiment of the present invention is suitable for email access. Consider the following situation. One has a regular email address used for all of one's business correspondence. In addition, one has a text pager or other wireless email reading device. While one's business email address is widely known, the pager address is only given to a small circle of close associates and friends. However, on occasion it is desirable for the email (of someone who is not a close associate) to be able to reach the pager or wireless email device. For example, in an academic setting, suppose someone is the editor of a journal. One often works on a very tight deadline to receive comments from reviewers of articles. The reviewers are typically not someone that an editor knows very well, but someone that they need to work with closely for a brief period of time. Conventional email filters provide for the ability to have mail that is sent to the business email address to be forwarded to the pager. A process according to another embodiment of the present invention eliminates the above problem.

A process according to another embodiment of the present invention is more suitable. A filter is created which specifies additional conditions under which email from this reviewer is to be forwarded to the pager, and under what circumstances this filter is to be deactivated. For example, a filter could be set for a fixed period of time, for example, the time until the final comments from the reviewer are due. After that, the filter is automatically deactivated. While the editor is working with the reviewer, email from that person is considered a high priority, and is forwarded to the pager. Once deactivated, email to the regular business address is still received for eventual reading by the editor, but is not forwarded to the pager for immediate attention. Or, the filter could deactivate as soon as the required document containing comments is sent—a one-time use filter. Additionally, the filter could use location information to forward to the pager while one is at work, but not if one is at home. Or it could make use of calendar information to check whether the person is currently in a meeting, and could wait to forward the email until the person is no longer in the meeting. All of this is accomplished without the need to disclose one's pager email address to the reviewer. One could also specify in this filter that feedback be provided automatically to the sender. For example, the reviewer may be as anxious as the editor about seeing that his review is received on time. While the filter is active it could send a notice to the sender that his email was forwarded to the editor's pager for immediate attention. After the filter is deactivated, such feedback is no longer provided.

One need not be limited to pager email addresses. For example, this same method could be used to forward email to one's personal (as opposed to business) email address.

Next, consider the situation of registering for a software product. Registration offers benefits such as offers of product upgrades, and notices of bug fixes. To receive these, one's email address is often required. In other situations, one may have to provide an email address in order to use a program for free during a limited time trial period. During the trial period, the person agrees to receive email advertisements. While both of these requests for one's email address have legitimate uses, this address may also be sold or passed on to others, or be used beyond the agreed on period. This leads to an annoying barrage of junk email. One can try to block it with filters typical of email programs today, but constructing such filters is a nuisance and time-consuming. Further, the only filter guaranteed to block all such unwanted email is one that blocks every other email. It is as if one's email address has become contaminated. The only way to truly get rid of the problematic email is to switch to a new email address, and notify all those with whom you wish to have continued correspondence of the change.

A process according to another embodiment of the present invention eliminates the above problem. A filter is created with an associated token when registering for a new software product. The token is an actual email address, generated just for the purpose of this software registration, which one supplies to the software manufacturer. The filter may specify a period of validity (e.g., the period during which free software upgrades are available, say a year). It could also specify that deactivation is triggered by the uninstallation of the software program. (This would handle the situation where one decides to get rid of the software even before the free trial period is over.) While the filter and its associated token is active, email sent to the email address is forwarded to the user's regular email address. At the end of the period, when the token is deactivated, email sent to the special address bounces back to the sender, who more than likely will then remove it from their distribution list.

In this way, one has provided for legitimate access to the user, without the user having to compromise their regular email address for the long term. Note also that the person only addresses the problem once: at the time of creation of the filter and token. There is no need to later construct a conventional email filter, or to unsubscribe from an unwanted mailing list. (Of course, the system could optionally offer you a notice of an email address about to be deleted. This could be provided to both the user as well as to the source of the mailing list, if desired.) As with the other examples, if the individual or entity can be identified by digital signature or other means, the token—in this case the individualized email address—is no longer essential to the proper functioning of an individualized filter of the type described above.

In summary, the components of the exemplary embodiment of the present invention include: (1) a database of state information (such as a calendar, a GPS location, one's current availability, etc.) (2) an application for creating (potentially limited-use), individualized filters, (3) a database holding one or more such filters, (4) an application that generates unique tokens, such as pin numbers or limited use email addresses, (5) an application which authenticates tokens (or a person's identity), and if valid, applies a related filter to authorize types of access to an individual and/or possibly generate a customized view of selected state information, and (6) communications mechanisms for (i) allowing a filtered view, (ii) providing access to the individual.

In the case of scheduling, this involves specifying the meeting constraints, duration the filter is valid, and parameters used to configure the calendar view parties will be given and access privileges they will have. In the cases of instant messaging, pager, cell phone, or wireless-email access, the token enables potential access. Access is determined by the associated filter and state information in the database. For example, a cell phone call from one's spouse might always be able to reach one but during an important meeting others might not have cell phone access. The database can contain information about an individual's location, schedule, state of work materials, status of various projects, desire to currently limit access, and a range of other information.

While this information can be entered manually, portions of it can be included and updated without conscious effort, as the byproduct of other activities. For example, location information could, at times, be automatically updated when GPS chips are incorporated in cell phones, cars, and other devices.

Although the invention has been described with applications using the Internet or telephone, it is readily apparent to one skilled in the art that access mediation can also provide limited duration access to privileges of an inner circle. Upon the need for such access, a specific filter customized to the particular circumstances can be created. And, it could also result from modifying a previously configured filter. Mediated access can take a variety of forms, for example, the token could be passed via a web connection, as described in the previous examples, or over a wireless network. The token could be a phone number to be called with extra digits to be keyed in once a connection to a server application is established. The token could even be constructed to be appropriate to be used in a verbal interchange with a person's secretary. Mediated access can also be exercised via the associated token at the convenience of the parties to whom one extends such privileges. The token might permit paging, placing a cell phone call, creating an IM connection, sending wireless email, or any combination of access. The token and execution of the associated filter determines whether access is granted. For example, in a cell phone connection, after the call concludes, the token might be deactivated as an automatic result of the filter. Note that the state of one's inner versus outer circle then reverts to what it was prior to the event. Notice also that the same mechanism can be used to further refine inner-outer distinctions to create multiple categories. This enables individuals to be temporarily recategorized so as to move them either inwardly to grant them additional access or outwardly to further restrict access. At any time access may be denied due to state information present in the database. For example, a called party may be in a location in which all filters automatically disable cell phone access.

Having described embodiments of a system and method for creating a unified printable collection of hyperlink documents, it is noted that modifications and variation can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A method of mediating access to a person's availability information via a communication medium, comprising the steps of:
creating one or more filters, each filter including information defining how the availability information is to be presented, a parameter used to identify an individual to whom the access is to be granted, and associating a filter with the individual;
identifying the individual when the individual attempts to access the filtered information;
retrieving the filter associated with the individual; and
presenting to the individual up-to-date availability information processed by the associated filter.

2. The method according to claim 1, further including the step of deactivating said one or more filters upon satisfaction of a preset condition relating to said filter.

3. The method according to claim 2, wherein said filtered information is prevented for access by the individual after said one or more filters is deactivated.

4. The method according to claim 1, wherein said step of identifying the individual is by digital signature.

5. The method according to claim 1, further including the steps of: associating a token with each filter; giving notice of the token to the individual; and use of the token for identifying the individual and determination of the associated filter.

6. The method of claim 1, wherein said filtered information is a filtered view of a calendar of the person.

7. The method of claim 1, wherein each of the one or more filters presents a different version of the person's availability information.

8. The method according to claim 1, wherein said communication medium is telephony.

9. The method according to claim 1, wherein said step of identifying the individual is by caller ID.

10. The method according to claim 1, wherein said communication medium is instant messaging.

11. A method of mediating access to a person via a communication medium, comprising the steps of:
creating one or more filters, each filter including information defining an individual's ability to arrange access to the person, and at least one parameter used to identify the individual to whom the access is to be granted;
identifying the individual when the individual attempts to arrange access to the person;
determining an appropriate filter based on identification of the individual; and
arranging for access to the person by the individual within the constraints established by the appropriate filter.

12. The method of claim 11, wherein said step of arranging for access to the person includes presenting to the individual up-to-date availability information of the person.

13. The method of claim 12, wherein said up-to-date availability information is presented through the appropriate filter upon identification of the individual.

14. The method of claim 12, wherein the individual up-to-date availability information of the person is dynamically updated by the appropriate filter and instantaneous availability information of the person is presented to the individual when the individual is identified.

15. The method of claim 13, wherein said up-to-date availability information is based on detection of the person's location.

16. The method of claim 15, wherein said detection of the person's location is by GPS.

17. The method of claim 11, wherein said communication medium is instant messaging on a global electronic network and whether access to the person by any individual depends on the individual identified.

18. The method of claim 11, further including the step of giving a token to the individual, said token for use in identifying the individual.

19. The method of claim 18, wherein said step of identifying the individual includes use of the token and one other identification means to authenticate the individual.

20. A program storage device having stored programs executable by a computer for performing method steps for mediating access to a person, the method comprising the steps of:
creating one or more filters, each filter for processing the availability information and to produce filtered information, each filtered information presenting a different version of the availability information;
setting parameters for identifying individuals intended to receive filtered information;
identifying individuals attempting to access filtered information, and selecting a filter based on the identified individual; and
presenting to the identified individual filtered information corresponding to the selected filter.
